(19) United States
(12) Patent Application Publication
(10) Pub. No.: US 2024/0086512 A1
(43) Pub. Date: Mar. 14, 2024

(54) ELECTRONIC DEVICE INCLUDING IMAGE SENSOR AND DYNAMIC VISON SENSOR, AND OPERATION METHOD THEREOF

(71) Applicant: Samsung Electronics Co., Ltd., Suwon-si (KR)

(72) Inventors: Jinhyun KIM, Suwon-si (KR); Jongwoon JANG, Suwon-si (KR); Sangjun YU, Suwon-si (KR); Inkoo KANG, Suwon-si (KR); Sungoh KIM, Suwon-si (KR); Ildo KIM, Suwon-si (KR); Jonghoon WON, Suwon-si (KR)

(21) Appl. No.: 18/510,175

(22) Filed: Nov. 15, 2023

Related U.S. Application Data
(63) Continuation of application No. PCT/KR2022/006682, filed on May 10, 2022.

(30) Foreign Application Priority Data
May 18, 2021 (KR) 10-2021-0064235

(51) Int. Cl. G06F 21/32; G06F 21/45; G06V 40/16; G06V 40/18; G06V 40/19; H04N 23/68; H04N 25/47

(52) U.S. Cl. CPC G06F 21/32; G06F 21/45; G06V 40/166; G06V 40/172; G06V 40/19; G06V 40/193; H04N 23/6812; H04N 23/683; H04N 25/47

(57) ABSTRACT

An example electronic device may receive user input in a state in which security of the electronic device is configured; based on receiving of the user input, display a designated screen on a display; acquire image data including a face of a user through an image sensor; detect a radial movement from a part of the face using a DVS while acquiring the image data; detect first face data corresponding to the face from the image data and compare the detected first face data with second face data stored in the electronic device; and, based on the detection of the radial movement and correspondence between the first face data and the second face data, release the state in which the security is configured.

### CROSS-REFERENCE TO RELATED APPLICATIONS

This application is a continuation of PCT/KR2022/006682, designating the United States, filed May 10, 2022, in the Korean Intellectual Property Receiving Office, which claims priority to Korean Patent Application No. 10-2021-0064235, filed on May 18, 2021, in the Korean Intellectual Property Office. The contents of each of these applications are incorporated by reference herein in their entireties.

### BACKGROUND

### Field

The disclosure relates to a biometric authentication technology using an image sensor and a dynamic vision sensor.

### Description of Related Art

Biometric authentication technology may include, for example, fingerprint authentication, voice authentication, signature authentication, or facial authentication. Facial authentication is an authentication technology of capturing a user's facial image and determining whether the user is a main user of an electronic device. Facial authentication technology is advantageous in that non-contact identification of a user is possible, unlike an authentication technology, such as fingerprint recognition, requiring a user's special motion. Recently, such facial authentication technology has become widely used in various application fields, such as a security system of an electronic device, mobile authentication, and searching for multimedia data, due to the convenience and efficiency of the facial authentication technology.

### SUMMARY

In conventional facial authentication technology, it is difficult for an electronic device to determine whether an image input for facial authentication is an image of the face of a real human body. Therefore, there is a problem in that it is possible for a fraudulent user rather than a main user registered in an electronic device to be facially authenticated using a photo or a model corresponding to the face of the main user.

An electronic device according to an example embodiment may include a display, an image sensor, a dynamic vision sensor (DVS), and at least one processor electrically connected to the display, the image sensor, and the DVS. The at least one processor may be configured to receive a user input in a state in which security of the electronic device is configured, display a designated screen on the display based on receiving of the user input, obtain image data including a user's face using the image sensor, detect a radial movement in a part of the face using the DVS while obtaining the image data, detect first facial data corresponding to the face in the image data and compare the first facial data with second facial data stored in the electronic device, and release the state in which the security is configured, based on the radial movement being detected and the first facial data corresponding to the second facial data.

An operation method of an electronic device according to an embodiment may include receiving a user input in a state in which security of the electronic device is configured, displaying a designated screen on a display included in the electronic device based on the receiving of the user input, obtaining image data including a user's face using an image sensor included in the electronic device, detecting a radial movement in a part of the face by using a dynamic vision sensor (DVS) included in the electronic device while obtaining the image data, detecting first facial data corresponding to the face in the image data and comparing the first facial data with second facial data stored in the electronic device, and releasing the state in which the security is configured, based on the radial movement being detected and the first facial data corresponding to the second facial data.

An electronic device according to an embodiment may include a display, an image sensor, a dynamic vision sensor (DVS), and at least one processor electrically connected to the display, the image sensor, and the DVS. The at least one processor may be configured to receive a user input in a state in which security of the electronic device is configured, display a designated screen on the display based on receiving of the user input, obtain image data including a user's face using the image sensor, obtain event data using the DVS while obtaining the image data, obtain a first area corresponding to the face in the image data, obtain a second area corresponding to the user's eye in the first area of the image data, obtain a third area corresponding to the second area in the event data, detect first facial data corresponding to the face in the first area of the image data and compare the first facial data with second facial data stored in the electronic device, detect a radial movement in the third area of the event data, and release the state in which the security is configured, based on the radial movement being detected and the first facial data corresponding to the second facial data.

According to various example embodiments, an electronic device may determine whether an image input for facial authentication is an image of the face of a real human body or an image of a photo or model. Therefore, the security of the electronic device may be reinforced.

According to various example embodiments, an electronic device uses a dynamic vision sensor (DVS) to perform facial authentication, and thus the volume of data associated with facial authentication may be reduced and a data processing speed may be increased.

Effects which are acquirable based on the disclosure are not limited to the effects described above, and other effects that have not been mentioned may be clearly understood from the following description.

### BRIEF DESCRIPTION OF THE DRAWINGS

The above and/or other aspects of the disclosure will be more apparent by describing certain embodiments of the disclosure with reference to the accompanying drawings, in which:

FIG. 1 illustrates an example electronic device according to various embodiments;

FIG. 2 is a block diagram illustrating a hardware configuration of an example electronic device according to various embodiments;

FIG. 3 is a flowchart illustrating an example operation of releasing a state in which security is configured, using an image sensor and a DVS according to various embodiments;

FIG. 4 illustrates an example of a radial movement that is detectable using a DVS according to various embodiments;

FIG. 5 illustrates an example of comparing first facial data with second facial data according to various embodiments;

FIG. 6 is a flowchart illustrating an example operation of releasing a state in which security is configured, using an image sensor and a DVS according to various embodiments;

FIG. 7 illustrates an example of a first area and a second area obtained in image data according to various embodiments;

FIG. 8 illustrates an example of a third area obtained in event data according to various embodiments;

FIG. 9 illustrates an example of a screen displayed on a display when the surrounding illuminance of an example electronic device is equal to or greater than a designated illuminance according to various embodiments;

FIG. 10 illustrates an example of an operation of storing second facial data in an example electronic device according to various embodiments;

FIG. 11 is a block diagram of an example electronic device in a network environment according to various embodiments; and

FIG. 12 is a block diagram showing an example of a camera module according to various embodiments.

### DETAILED DESCRIPTION

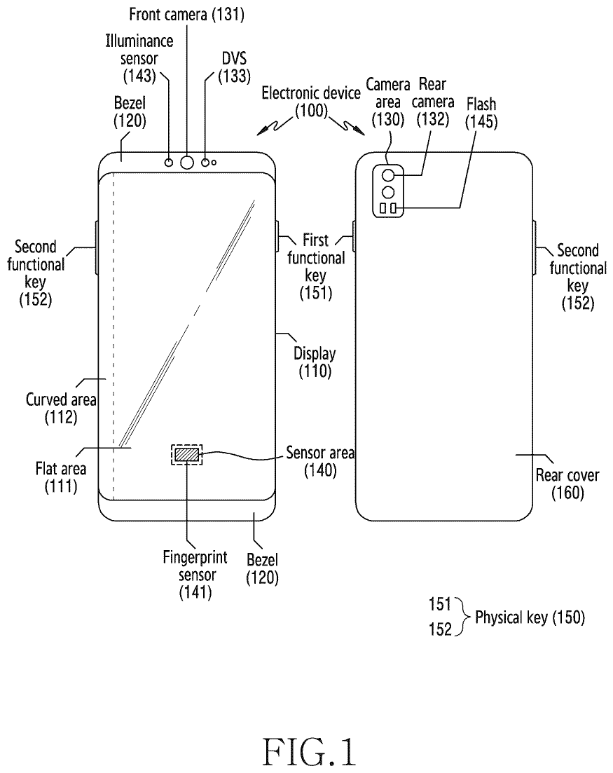

FIG. 1 illustrates an example electronic device 100 according to various embodiments.

Referring to FIG. 1, a display 110 may be disposed on a front surface of the electronic device 100 according to an embodiment. In an embodiment, the display 110 may cover most of the front surface of the electronic device 100. The display 110 and an area of a bezel 120 surrounding at least a partial edge of the display 110 may be arranged on the front surface of the electronic device 100. In an example of FIG. 1, the display 110 may include a flat area 111 and a curved area 112 extending from the flat area 111 toward a lateral surface of the electronic device 100. In FIG. 1, the curved area 112 is illustrated only at one side (e.g., left side), but, in an embodiment, the curved area may be understood as being identically provided at the opposite side. In addition, the electronic device 100 illustrated in FIG. 1 is one example, and various embodiments are possible. For example, the display 110 of the electronic device 100 may include only the flat area 111 without the curved area 112, or have the curved area 112 only at the edge of one side rather than both sides. In addition, in an embodiment, the curved area may extend to a rear surface of the electronic device 100 and thus the electronic device 100 may have an additional flat area.

In an embodiment, a fingerprint sensor 141 for recognition of a user's fingerprint may be included in a sensor area 140 of the display 110. The fingerprint sensor 141 is disposed on a layer under the display 110, and thus may be invisible to a user or may be difficult to be seen. In addition, a sensor for additional user/biometric authentication other than the fingerprint sensor 141 may be disposed on a partial area of the display 110. In an embodiment, a sensor for user/biometric authentication may be disposed on one area of the bezel 120. For example, an IR sensor for iris authentication may be exposed through one area of the display 110 or be exposed through one area of the bezel 120.

In an embodiment, a sensor may be included in at least one area of the bezel 120 of the electronic device 100 or at least one area of the display 110. In an embodiment, the sensor may be a sensor for distance detection and/or a sensor for object detection. For example, the sensor may be operated as at least a part of an infrared (IR) camera (e.g., a time-of-flight (TOF) camera or a structured light camera), or may be operated as at least a part of a sensor module. In an embodiment, the sensor may be an illuminance sensor 143 capable of detecting the surrounding illuminance of the electronic device 100. The illuminance sensor 143 may be disposed to be adjacent to a camera module (e.g., a front camera 131 or a rear camera 132).

In an embodiment, the front camera 131 may be disposed on the front surface of the electronic device 100. In the embodiment of FIG. 1, the front camera 131 is illustrated as being exposed through one area of the bezel 120, but in another embodiment, the front camera 131 may be exposed through the display 110.

In an embodiment, at least one of a sensor module, a camera module (e.g., the front camera 131 or the rear camera 132), and a light emitting element (e.g., LED) may be disposed on a back surface of a screen display area (e.g., the flat area 111 or the curved area 112) of the display 110.

In an embodiment, a camera module may be disposed on a back surface of at least one surface among the front surface, the lateral surface, and/or the rear surface of the electronic device 100 toward the front surface, the lateral surface, and/or the rear surface. For example, the front camera 131 may be a hidden under display camera (UDC) that is not visually exposed on a screen display area (e.g., the flat area 111 or the curved area 112). In an embodiment, the electronic device 100 may include one or more front cameras 131. For example, the electronic device 100 may include two front cameras, such as a first front camera and a second front camera. In an embodiment, the first front camera and the second front camera may be the same type of cameras having equivalent specifications (e.g., pixel counts), but the first front camera and the second front camera may be implemented as cameras with different specifications. The electronic device 100 may support a function (e.g., 3D image capturing, auto focus, etc.) related to a dual camera with the two front cameras.

In an embodiment, a dynamic vision sensor (DVS) 133 may be included in at least one area of the bezel 120 of the electronic device 100 or at least one area of the display 110. The DVS 133 may be disposed to be adjacent to the front camera 131.

In an embodiment, the rear camera 132 may be disposed on the rear surface of the electronic device 100. The rear camera 132 may be exposed through a camera area 130 of a rear cover 160. In an embodiment, the electronic device 100 may include multiple rear cameras arranged in the camera area 130. For example, the electronic device 100 may include two or more rear cameras. For example, the electronic device 100 may include a first rear camera, a second rear camera, and a third rear camera. The first rear camera, the second rear camera, and the third rear camera may have different specifications. For example, the first rear camera, the second rear camera, and the third rear camera may have different FOVs, pixel counts, apertures, support for optical zoom/digital zoom, support for a shake correction function, and/or types and/or arrangements of a lens set included in each camera. For example, the first rear camera may be a normal camera, the second rear camera may be a camera (e.g., a wide-angle camera) for wide shooting, and the third rear camera may be a camera (e.g., a telephoto camera) for telephoto shooting. In various embodiments, a description related to the functions and characteristics of the front camera may also be applied to the rear camera, and vice versa.

In an embodiment, various types of hardware or sensors, such as a flash 145, assisting image capturing may be additionally disposed in the camera area 130. For example, various sensors, such as a distance sensor for detecting the distance between a subject and the electronic device 100, may be further included.

In an embodiment, the distance sensor may be disposed to be adjacent to a camera module (e.g., the front camera 131 or the rear camera 132) or may be integrated with the camera module. For example, the distance sensor may be operated as at least a part of an infrared (IR) camera (e.g., a time-of-flight (TOF) camera or a structured light camera), or may be operated as at least a part of a sensor module. For example, the TOF camera may be operated as at least a part of a sensor module for detecting a distance from a subject.

In an embodiment, at least one physical key 150 may be disposed on a lateral part of the electronic device 100. For example, a first functional key 151 for turning on/off the display 110 or turning on/off the power of the electronic device 100 may be disposed on a right edge with respect to the front surface of the electronic device 100. For example, a second functional key 152 for controlling the volume or screen brightness of the electronic device 100 may be disposed on a left edge with respect to the front surface of the electronic device 100. Other additional buttons or keys may be arranged on the front surface or the rear surface of the electronic device 100. For example, a physical button or a touch button mapped to a particular function may be disposed on a lower area of the bezel 120 on the front surface.

The electronic device 100 illustrated in FIG. 1 corresponds to an example, and does not limit the shape of a device to which the technical concepts of this disclosure may be applied. For example, the technical concepts of this disclosure may also be applied to a foldable electronic device, tablet, or notebook that employs a flexible display 110 and a hinge structure and is thus foldable horizontally or vertically. In addition, the electronic device 100 of FIG. 1 is illustrated as having a bar-type or plate-type exterior, but the disclosure is not limited in this respect. For example, the illustrated electronic device may be a part of a rollable electronic device. The rollable electronic device may be understood as an electronic device in which the display 110 is flexible and thus at least a part of the display 110 is windable or rollable, or is receivable into the electronic device 100. The rollable electronic device may extend and use a screen display region (e.g., the flat area 111 or the curved area 112) by unfolding the display 110 or exposing a wider area of the display 110 to the outside according to a user's need. The display 110 may be called a slide-out display or an expandable display.

Hereinafter, for convenience of explanation, various embodiments will be described with reference to the electronic device 100 illustrated in FIG. 1.

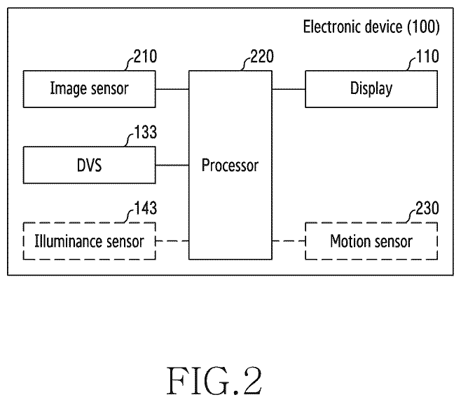

FIG. 2 is a block diagram illustrating a hardware configuration of the example electronic device 100 according to various embodiments.

Referring to FIG. 2, the electronic device 100 may include an image sensor 210, the DVS 133, a processor 220, and the display 110. In an embodiment, the electronic device 100 may further include the illuminance sensor 143 and a motion sensor 230. Among the elements illustrated in FIG. 2, the elements described with reference to FIG. 1 may be briefly described or not described.

According to an embodiment, the electronic device 100 may include the image sensor 210. According to an embodiment, the image sensor 210 may be understood as being included in the front camera 131.

According to an embodiment, the image sensor 210 may be a complementary metal oxide semiconductor (CMOS) sensor or a charged coupled device (CCD) sensor. Multiple individual pixels are integrated in the image sensor 210, and each individual pixel may include a micro lens, a color filter, and a photodiode. Each individual pixel is a type of photodetector, and may convert the light entering the electronic device 100 into an electrical signal. The photodetector may include a photodiode. For example, the image sensor 210 may amplify the current generated through the photoelectric effect of a light receiving element caused by the light received through a lens assembly. For example, each individual pixel may include a photoelectric transformation element (or a light-detecting element (position sensitive detector, PSD)) and multiple transistors (e.g., a reset transistor, a transfer transistor, a select transistor, and a driver transistor).

According to an embodiment, the image sensor 210 may obtain image data corresponding to light incident into the electronic device 100. The image sensor 210 may provide image data corresponding to incident light to the processor 220. For example, the processor 220 may obtain image data corresponding to a user's face from the image sensor 210.

According to an embodiment, the DVS 133 may be disposed on one surface of the electronic device 100 so as to face the same direction as the image sensor 210. For example, the DVS 133 and the image sensor 210 may be disposed on a back surface (or back side) of the front surface of the electronic device 100 toward the front surface of the electronic device 100. As another example, the DVS 133 and the image sensor 210 may be disposed on a back surface of at least one surface among the front surface, the lateral surface, and/or the rear surface of the electronic device 100 toward at least one surface among the front surface, the lateral surface, and/or the rear surface.

According to an embodiment, multiple individual pixels may be integrated in the DVS 133. For example, an individual pixel included in the DVS 133 may be distinguished from an individual pixel included in the image sensor 210. According to an embodiment, the DVS 133 may detect, using each individual pixel, an event in which the intensity of the light incident into the electronic device 100 changes, and output event data corresponding to the event. For example, the DVS 133 may determine whether an event in which light intensity changes has occurred for each individual pixel, and determine whether the event is an event in which the light intensity increases or an event in which the light intensity decreases. The DVS 133 may determine that an event has occurred, when a light intensity change measured in an individual pixel is equal to or greater than a threshold value. The DVS 133 may obtain event data, based on an individual pixel in which an event is detected. The DVS 133 may provide the image data to the processor 220.

According to an embodiment, event data output by the DVS 133 may have a volume smaller than that of image data output by the image sensor 210. For example, event data may not include data relating to an individual pixel for which there is no change in the light intensity measured in the individual pixel, or the intensity change is smaller than the threshold value.

According to an embodiment, the processor 220 may be understood as including at least one processor (including, e.g., processing circuitry). For example, the processor 220 may include at least one of an application processor (AP), an image signal processor (ISP), and a communication processor (CP).

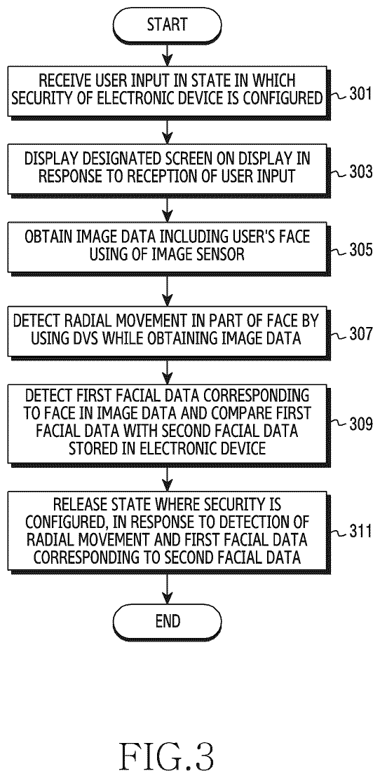

According to an embodiment, the display 110 may display an execution screen of an application (e.g., a camera application, a gallery application, or an application associated with the security of the electronic device 100) that is executed by the processor 220. For example, when a user input is received in a state in which security of the electronic device 100 is configured, the processor 220 may display a designated screen on the display 110. The designated screen will be described later with reference to FIG. 3.

According to an embodiment, the display 110 may be integrated with a touch panel. The display 110 may support a touch function, detect a user input (e.g., a touch using a finger), and transfer the user input to the processor 220. According to an embodiment, the display 110 may be connected to a display driver integrated circuit (DDIC) for driving the display 110, and the touch panel may be connected to a touch IC that detects touch coordinates and processes a touch-related algorithm. In an embodiment, the display driver integrated circuit and the touch IC may be integrated with each other. In an embodiment, the display driver integrated circuit and the touch IC may be separately provided. The display driver integrated circuit and/or the touch IC may be electrically connected to the processor 220.

According to an embodiment, the electronic device 100 may include the illuminance sensor 143. The processor 220 may measure the illuminance (or brightness) around the electronic device 100 using the illuminance sensor 143. In an embodiment, the processor 220 may determine whether the measured illuminance is less than a designated illuminance. In an embodiment, the processor 220 may determine whether the measured illuminance is equal to or greater than the designated illuminance.

According to an embodiment, the electronic device 100 may further include the motion sensor 230. The processor 220 may detect a movement of the electronic device 100 using the motion sensor 230. In an embodiment, the motion sensor 230 may include an acceleration sensor, a gyro sensor (gyroscope), a magnetic sensor, or a Hall sensor. For example, the acceleration sensor may measure accelerations applied in three axes (e.g., x-axis, y-axis, or z-axis) of the electronic device 100. However, the above sensors are examples, and the motion sensor may further include at least a different type of sensor. According to an embodiment, the motion sensor 230 may provide motion data corresponding to a movement of the electronic device 100 to the processor 220.

FIG. 3 is a flowchart illustrating an example operation of releasing a state in which security is configured, using the image sensor 210 and the DVS 133 according to an embodiment. The operation illustrated in FIG. 3 may be performed, for example, by the processor 220 illustrated in FIG. 2.

According to an embodiment, in operation 301, the processor 220 may receive a user input in a state in which security of the electronic device 100 is configured. For example, memory storing instructions that, when executed by the at least one processor, is configured to cause the electronic device 100 to receive a user input in a state in which security of the electronic device 100 is configured.

According to an embodiment, the processor 220 may receive a user input through the physical key 150 in a state in which security of the electronic device 100 is configured. For example, the processor 220 may receive a user input to turn on the display 110, through the first functional key 151. According to an embodiment, a user input made through the physical key 150 may be understood as an input to release a state in which security of the electronic device 100 is configured.

In relation to operation 301, the user input has been described as being a user input received through the physical key 150, but this merely corresponds to an example, and various embodiments are possible. In an embodiment, the user input may include an input on a touch button disposed on a partial area of the bezel 120, or a touch input on at least one area of the display 110. For example, when two or more consecutive touch inputs are received on one area of the display 110 while the display 110 is turned off, the electronic device 100 may determine that the user input has been received. In an embodiment, when a user viewing the display 110 is recognized while the display 110 is turned off, the processor 220 may recognize that the user input has been received.

According to an embodiment, in operation 303, the processor 220 may display a designated screen on the display 110 based on receiving of a user input. For example, memory storing instructions that, when executed by the at least one processor, is configured to cause the electronic device 100 to display a designated screen on the display 110 based on receiving of a user input.

According to an embodiment, when a user input is received while the display 110 is turned off, the processor 220 may turn on the display 110.

According to an embodiment, the processor 220 may display a screen associated with a state in which security is configured for the display 110, on the display 110 based on receiving of a user input. For example, the processor 220 may display a message notifying that security is currently configured for the display 110 and facial authentication for releasing the security is proceeding, and/or a user interface (UI) including the message. According to an embodiment, the processor 220 may display a random screen having a particular brightness or greater on the display 110 based on receiving of a user input. For example, the designated screen is provided to change a user's iris size according to a change of the quantity of the light emitted from the display 110, and thus the processor 220 may display a random screen (e.g., an image) having a particular brightness or greater on the display 110.

According to an embodiment, in operation 305, the processor 220 may obtain image data including a user's face using the image sensor 210. For example, memory storing instructions that, when executed by the at least one processor, is configured to cause the electronic device 100 to obtain image data including a user's face using the image sensor 210. According to an embodiment, the processor 220 may obtain image data including a user's face using the image sensor 210 of the front camera 131.

According to an embodiment, in operation 307, the processor 220 may detect a radial movement in a part of the face using the DVS 133 while obtaining the image data. For example, memory storing instructions that, when executed by the at least one processor, is configured to cause the electronic device 100 to detect a radial movement in a part of the face using the DVS 133 while obtaining the image data.

According to an embodiment, the processor 220 may obtain event data using the DVS 133, while obtaining image data using the image sensor 210. For example, the event data may include information on a movement detected in a part of the user's face.

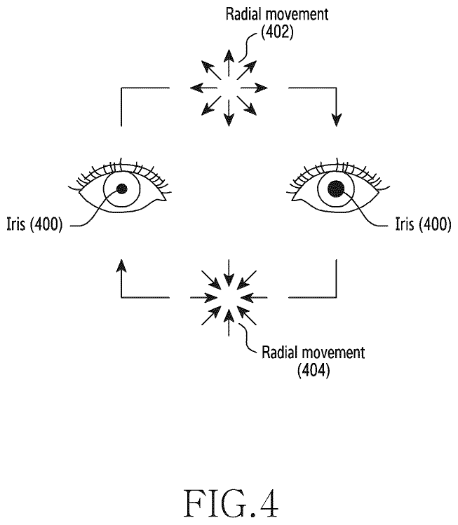

According to an embodiment, the processor 220 may detect a radial movement generated by reduction of the user's iris size using the DVS 133, while a designated screen is displayed on the display 110. For example, while a designated screen is displayed on the display 110, the quantity of light emitted from the display 110 may increase. When the light quantity increases, the user's iris size may be reduced. The DVS 133 may detect a movement caused by an iris size change in an area corresponding to irises in the user's face. Event data output by the DVS 133 may include information on a radial movement generated by reduction of the iris size. A description relating to the iris size will be given with reference to FIG. 4.

According to an embodiment, in operation 309, the processor 220 may detect first facial data corresponding to the user's face in image data, and compare the first facial data with second facial data stored in the electronic device 100. For example, memory storing instructions that, when executed by the at least one processor, is configured to cause the electronic device 100 to detect first facial data corresponding to the user's face in image data, and compare the first facial data with second facial data stored in the electronic device 100.

According to an embodiment, the processor 220 may detect first facial data corresponding to the user's face in image data. For example, first facial data may include information enabling specification of the user's face.

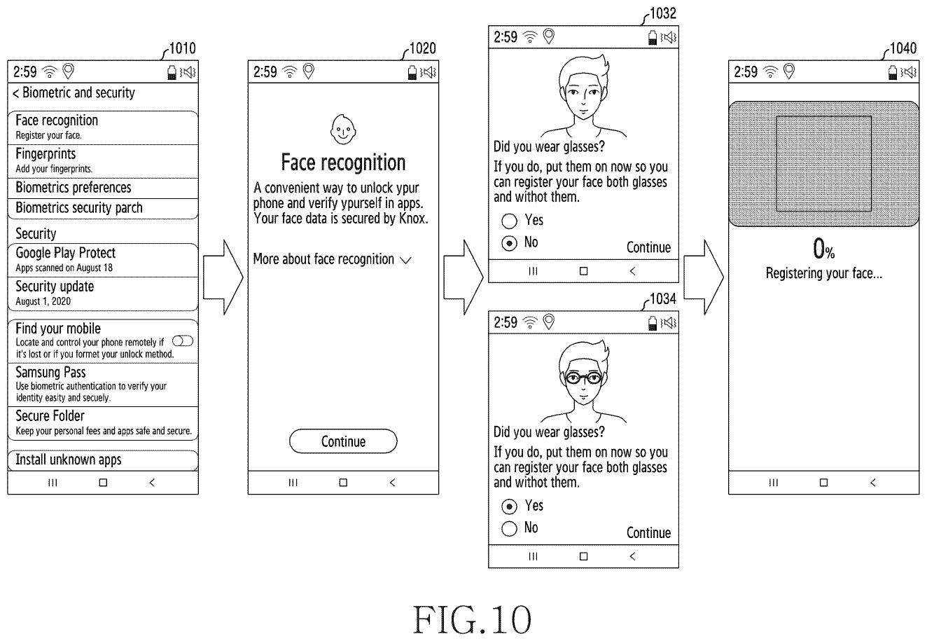

According to an embodiment, the processor 220 may compare the detected first facial data with second facial data stored in the electronic device 100. According to an embodiment, the electronic device 100 may perform an operation of storing second facial data before performing the operations illustrated in FIG. 3. Second facial data may include information enabling specification of the face of a main user of the electronic device 100. For example, the main user may be identical to or different from the user described in operation 301, operation 305, and operation 307. The operation of storing second facial data will be described below with reference to FIG. 10.

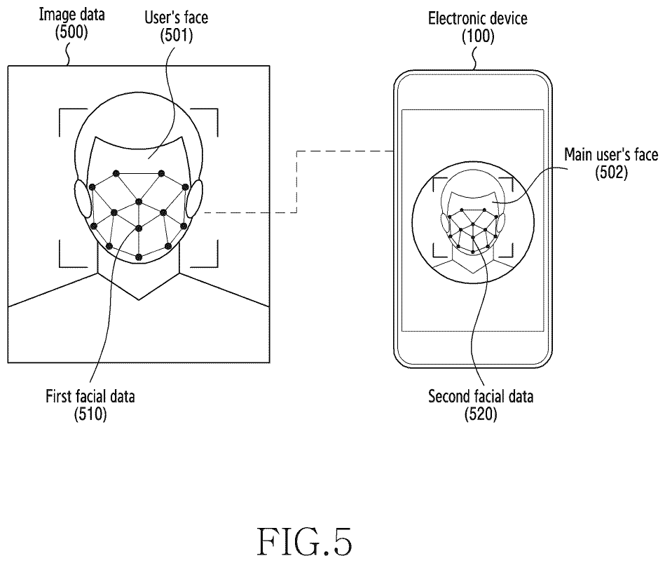

According to an embodiment, the processor 220 may compare first facial data with second facial data to determine whether the first facial data corresponds to the second facial data. The first facial data and the second facial data will be described later with reference to FIG. 5.

According to an embodiment, in operation 311, the processor 220 may release a state in which security is configured, based on detection of a radial movement and first facial data corresponding to second facial data. For example, memory storing instructions that, when executed by the at least one processor, is configured to cause the electronic device 100 to release a state in which security is configured, based on detection of a radial movement and first facial data corresponding to second facial data.

According to an embodiment, when first facial data corresponds to second facial data, the processor 220 may determine that the user's face included in image data matches the face of the main user of the electronic device 100. For example, when the main user of the electronic device 100 is to release security of the electronic device 100, first facial data may correspond to second facial data. As another example, even when a user other than the main user of the electronic device 100 uses a photo or a model (e.g., 3D mask) including the main user's face to release security of the electronic device 100, first facial data may correspond to second facial data.

According to an embodiment, the processor 220 may release security by considering whether a radial movement is detected using the DVS 133, together with whether first facial data corresponds to second facial data. The processor 220 may determine whether the face included in image data is the face of a real human body, using whether the radial movement is detected. For example, in a case in which the main user of the electronic device 100 is to release security of the electronic device 100, the quantity of the light emitted from the display 110 may increase and the iris size of the main user may be decreased, and the processor 220 may detect a radial movement corresponding to the iris reduction using the DVS 133. As another example, in a case in which a user other than the main user of the electronic device 100 uses a photo or a model including the main user's face, even when the quantity of the light emitted from the display 110 changes, the iris size does not change, and thus the processor 220 may have difficulty in detecting a radial movement using the DVS 133.

According to an embodiment, the processor 220 may maintain a state in which security is configured, when detection of a radial movement using the DVS 133 fails, or first facial data detected in image data does not correspond to second facial data. For example, even in a case in which first facial data corresponds to second facial data, when detection of a radial movement using the DVS 133 fails, the face included in image data may be a photo or a model including the main user's face rather than the real face of the main user, and thus the processor 220 may maintain a state in which security is configured. As another example, even in a case in which detection of a radial movement using the DVS 133 is successful, when first facial data does not correspond to second facial data, a user to release security of the electronic device 100 is not the main user of the electronic device 100, and thus the processor 220 may maintain a state in which security is configured.

FIG. 4 illustrates an example of a radial movement 402 or 404 that are detectable using the DVS 133 according to various embodiments.

According to an embodiment, the processor 220 may detect the radial movement 402 or 404 in a part of a user's face by using the DVS 133, while obtaining image data using the image sensor 210. According to an embodiment, the processor 220 may detect the radial movement 402 or 404 in an area corresponding to the user's eyes from event data obtained using the DVS 133.

Referring to FIG. 4, the size of an iris 400 of a real human body changes depending on light quantity. For example, the brighter the surrounding environment, the smaller the size of the iris 400. As another example, the darker the surrounding environment, the larger the size of the iris 400.

According to an embodiment, the processor 220 may detect a movement caused by the size change of the iris 400 using the DVS 133. For example, in a situation in which the display 110 is oriented toward the user's eyes, when the quantity of the light emitted from the display 110 decreases, the size of the user's iris 400 may increase. When the size of the user's iris 400 increases, the DVS 133 may detect the radial movement 402 caused by the size expansion of the iris 400. The processor 220 may determine that the radial movement 402 is included in event data obtained from the DVS 133. As another example, in a situation in which the display 110 is oriented toward the user's eyes, when the quantity of the light emitted from the display 110 increases, the size of the user's iris 400 may decrease. When the size of the user's iris 400 decreases, the DVS 133 may detect the radial movement 404 caused by the size reduction of the iris 400. The processor 220 may determine that the radial movement 404 is included in event data obtained from the DVS 133.

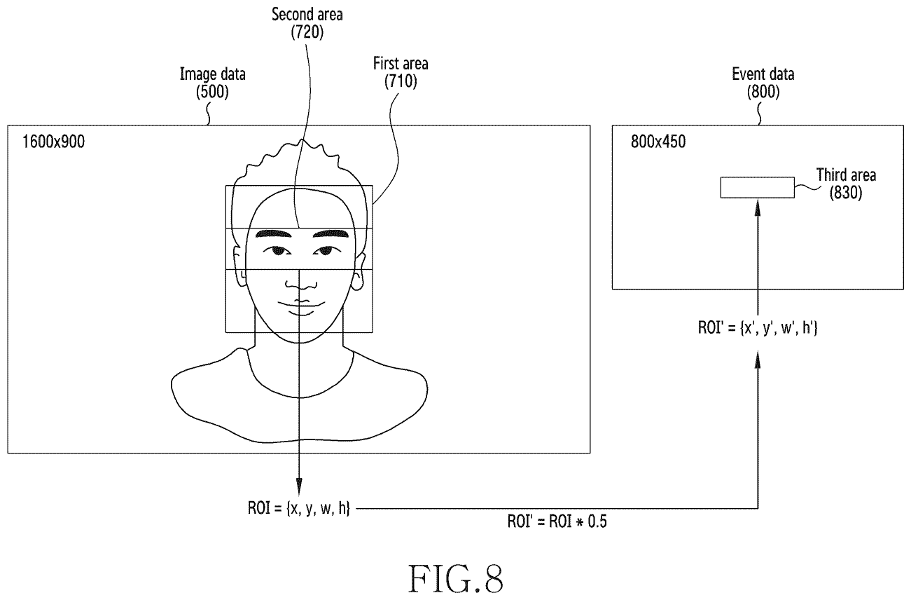

According to an embodiment, the processor 220 may detect the radial movement 402 or 404 in at least a partial area of event data obtained using the DVS 133. An area of event data will be described below with reference to FIG. 8.

According to an embodiment, when the radial movement 402 or 404 is not detected using the DVS 133, the processor 220 may determine that the user's face included in image data is not the face of a real human body. For example, when the processor 220 fails to detect the radial movement 402 or 404 using the DVS 133, the user's face included in image data may correspond to a photo or a model including the user's face rather than a real human body. Therefore, in comparison with a case in which the processor 220 does not determine, using the DVS 133, whether the radial movement 404 is detected, when the processor 220 detects the radial movement 404 together while comparing first facial data with second facial data, the security of the electronic device 100 may be reinforced.

According to an embodiment, in a case in which the processor 220 detects the radial movement 404 caused by the size reduction of the iris 400 using the DVS 133, in comparison with a case in which the size change of the iris 400 is detected using the image sensor 210, a detection speed is fast, data volume is reduced, and power consumption of the battery may be reduced. For example, in a case in which the processor 220 detects the radial movement 404 in event data, in comparison with a case in which image processing of image data is performed to detect the size change of the iris 400, a data processing speed may be faster. In addition, the volume of event data is smaller than that of image data, and thus a processing speed may be increased and data volume may be reduced.

FIG. 5 illustrates an example of comparing first facial data 510 with second facial data 520 according to various embodiments.

According to an embodiment, the processor 220 may obtain the first facial data 510 corresponding to a user's face 501 in image data 500 obtained from the image sensor 210. For example, the processor 220 may analyze the image data 500 to extract feature points of the face included in the image data 500, and obtain the first facial data 510 including information on relative positions between feature points.

According to an embodiment, the processor 220 may compare the detected first facial data 510 with the second facial data 520 stored in the electronic device 100. For example, the second facial data 520 may include information on feature points included in a face 502 of a main user of the electronic device 100, and/or information on relative positions between the feature points.

According to an embodiment, the processor 220 may compare the first facial data 510 with the second facial data 520 to determine whether the first facial data 510 corresponds to the second facial data 520. For example, the processor 220 may determine whether a positional relation between feature points included in the first facial data 510 corresponds to a positional relation between feature positions included in the second facial data 520.

According to an embodiment, when the first facial data 510 corresponds to the second facial data 520, the processor 220 may determine that the user's face 501 included in the image data 500 is the face 502 of the main user of the electronic device 100. According to an embodiment, when the first facial data 510 does not correspond to the second facial data 520, the processor 220 may determine that the user's face 501 included in the image data 500 is not the face 502 of the main user of the electronic device 100. When the first facial data 510 does not correspond to the second facial data 520, the processor 220 may maintain a state in which security of the electronic device 100 is configured.

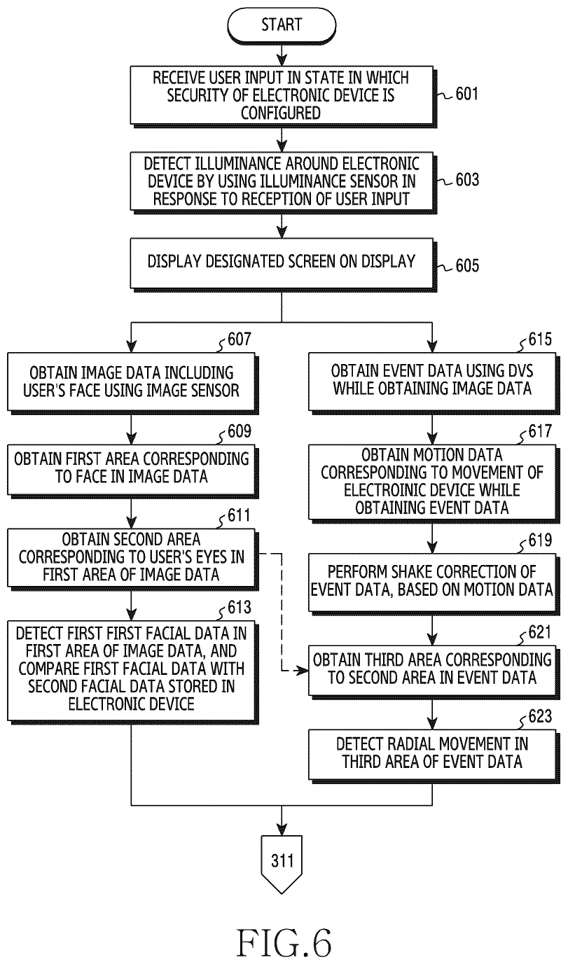

FIG. 6 is a flowchart illustrating an example operation of releasing a state in which security is configured, using the image sensor 210 and the DVS 133 according to an embodiment. The operation illustrated in FIG. 6 may be performed, for example, by the processor 220 illustrated in FIG. 2.

According to an embodiment, in operation 601, the processor 220 may receive a user input in a state in which security of the electronic device 100 is configured. Operation 601 may correspond to operation 301 of FIG. 3. For example, memory storing instructions that, when executed by the at least one processor, is configured to cause the electronic device 100 to receive a user input in a state in which security of the electronic device 100 is configured. Operation 601 may correspond to operation 301 of FIG. 3.

According to an embodiment, in operation 603, the processor 220 may detect the illuminance around the electronic device 100 using the illuminance sensor 143 based on receiving of a user input. For example, memory storing instructions that, when executed by the at least one processor, is configured to cause the electronic device 100 to detect the illuminance around the electronic device 100 using the illuminance sensor 143 based on receiving of a user input.

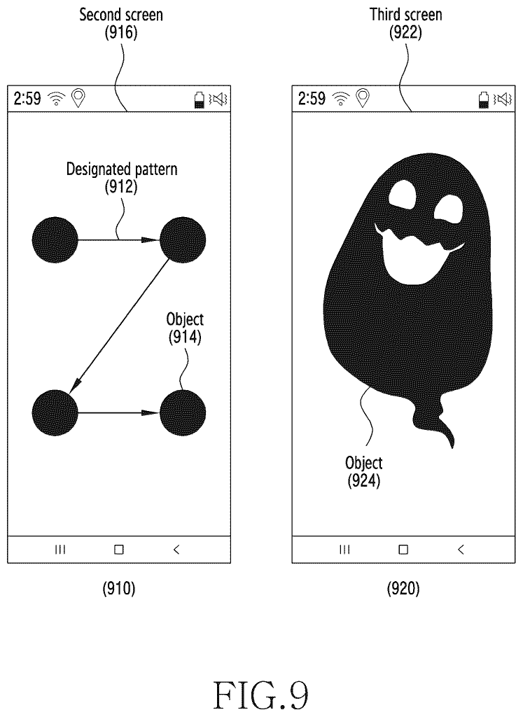

According to an embodiment, the processor 220 may determine, using the illuminance sensor 143, whether the illuminance around the electronic device 100 is less than a designated illuminance. According to an embodiment, the processor 220 may perform operation 605 of FIG. 6 based on the illuminance around the electronic device 100 being less than the designated illuminance. According to an embodiment, the processor 220 may display a screen different from a designated screen on the display 110 unlike operation 605 based on the illuminance around the electronic device 100 being equal to or greater than the designated illuminance. A case in which the illuminance around the electronic device 100 is equal to or greater than the designated illuminance will be described later with reference to FIG. 9.

According to an embodiment, in operation 605, the processor 220 may display a designated screen on the display 110. Operation 605 may correspond to operation 303 of FIG. 3. For example, memory storing instructions that, when executed by the at least one processor, is configured to cause the electronic device 100 to display a designated screen on the display 110. Operation 605 may correspond to operation 303 of FIG. 3.

According to an embodiment, in operation 607, the processor 220 may obtain image data including a user's face using the image sensor 210. Operation 607 may correspond to operation 305 of FIG. 3. For example, memory storing instructions that, when executed by the at least one processor, is configured to cause the electronic device 100 to obtain image data including a user's face using the image sensor 210. Operation 607 may correspond to operation 305 of FIG. 3.

According to an embodiment, in operation 609, the processor 220 may obtain a first area corresponding to the face in the image data. For example, memory storing instructions that, when executed by the at least one processor, is configured to cause the electronic device 100 to obtain a first area corresponding to the face in the image data.

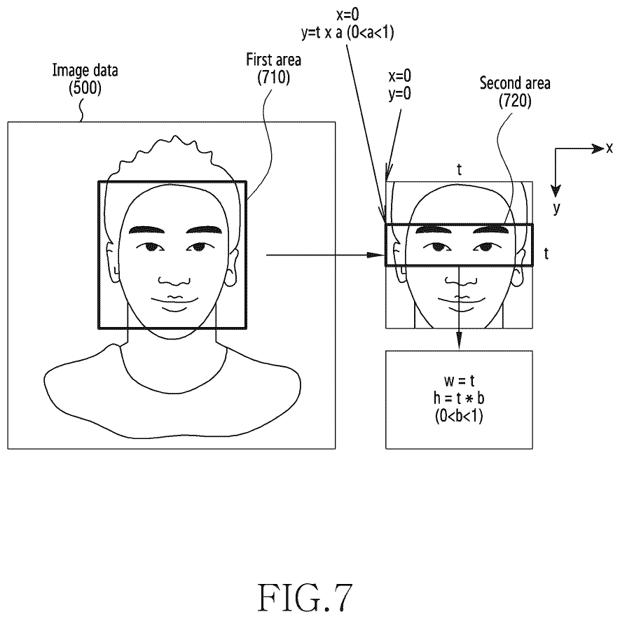

According to an embodiment, in operation 611, the processor 220 may obtain a second area corresponding to the user's eyes in the first area of the image data. For example, memory storing instructions that, when executed by the at least one processor, is configured to cause the electronic device 100 to obtain a second area corresponding to the user's eyes in the first area of the image data. For example, the second area may be included in the first area. The first area and the second area of the image data will be described below with reference to FIG. 7.

According to an embodiment, in operation 613, the processor 220 may detect first facial data in the first area of the image data, and compare the first facial data with second facial data stored in the electronic device 100. For example, memory storing instructions that, when executed by the at least one processor, is configured to cause the electronic device 100 to detect first facial data in the first area of the image data, and compare the first facial data with second facial data stored in the electronic device 100. In an embodiment, the first facial data and the second facial data of operation 613 may correspond to the first facial data and the second facial data described with reference to FIG. 3 and FIG. 5.

According to an embodiment, in operation 615, the processor 220 may obtain event data using the DVS 133 while obtaining image data. For example, memory storing instructions that, when executed by the at least one processor, is configured to cause the electronic device 100 to obtain event data using the DVS 133 while obtaining image data.

According to an embodiment, in operation 617, the processor 220 may obtain motion data corresponding to a movement of the electronic device 100 while obtaining event data. For example, memory storing instructions that, when executed by the at least one processor, is configured to cause the electronic device 100 to obtain motion data corresponding to a movement of the electronic device 100 while obtaining event data.

According to an embodiment, the processor 220 may obtain motion data corresponding to a movement of the electronic device 100 using the motion sensor 230 while obtaining event data.

According to an embodiment, the processor 220 may obtain motion data, based on event data obtained using the DVS 133. For example, the processor 220 may detect a global motion corresponding to a movement of the electronic device 100 in event data obtained in operation 615. The processor 220 may obtain the motion data by analyzing the event data.

According to an embodiment, in operation 619, the processor 220 may perform shake correction of event data, based on motion data. For example, memory storing instructions that, when executed by the at least one processor, is configured to cause the electronic device 100 to perform shake correction of event data, based on motion data.

According to an embodiment, when the electronic device 100 shakes while the DVS 133 obtains event data, the processor 220 may have difficulty in detecting a radial movement (e.g., the radial movement 404 in FIG. 4) in the event data. Therefore, the processor 220 may perform shake correction of event data, based on motion data obtained while obtaining the event data. Event data, shake correction of which has been performed, may not include a global motion. In an embodiment, the processor 220 may perform the shake correction, based on motion data obtained using the motion sensor 230, and in an embodiment, the processor 220 may also perform the shake correction, based on motion data obtained from event data.

According to an embodiment, in operation 621, the processor 220 may obtain, in event data, a third area corresponding to the second area of the image data. For example, memory storing instructions that, when executed by the at least one processor, is configured to cause the electronic device 100 to obtain, in event data, a third area corresponding to the second area of the image data. According to an embodiment, the processor 220 may obtain the third area corresponding to the second area in event data, shake correction of which has been performed in operation 619.

According to an embodiment, in operation 623, the processor 220 may detect a radial movement in the third area of the event data. For example, memory storing instructions that, when executed by the at least one processor, is configured to cause the electronic device 100 to detect a radial movement in the third area of the event data.

According to an embodiment, the processor 220 may perform operation 311 of FIG. 3, based on whether the first facial data corresponds to the second facial data, which is determined in operation 613, and based on the radial movement detected in operation 623.

FIG. 7 illustrates an example of a first area 710 and a second area 720 obtained in the image data 500 according to various embodiments.

According to an embodiment, the processor 220 may obtain the image data 500 including a user's face from the image sensor 210. According to an embodiment, the processor 220 may obtain the first area 710 corresponding to the user's face in the image data 500. For example, the processor 220 may determine the first area 710 including at least a part of the user's face by analyzing the image data 500.

According to an embodiment, the processor 220 may detect first facial data (e.g., the first facial data 510 in FIG. 5) in the first area 710 of the image data 500. According to an embodiment, the processor 220 may determine at least a partial area of the image data 500 as the first area 710 so that an area required for detecting at least the first facial data is included in the first area 710. For example, the processor 220 may determine the first area 710 so as to extract a feature point of the face in the user's face included in the first area 710. For example, the processor 220 may determine the first area 710 so that the user's eyes, eyebrows, nose, mouth, ears, and forehead are included in the first area 710.

According to an embodiment, the processor 220 may obtain the second area 720 corresponding to the user's eyes in the first area 710 of the image data 500. For example, the processor 220 may determine a partial area of the first area 710 as the second area 720 so that the second area includes the user's eyes.

According to an embodiment, the processor 220 may determine a partial area of the first area 710 as the second area 720 using a relation between the first area 710 and the second area 720. For example, the electronic device 100 may store, in advance, information on the size and coordinates of an area in which the eyes are located in the user's face. The processor 220 may analyze the image data 500 to determine the first area 710, and determine a part of the first area 710 as the second area 720, based on the stored information.

Referring to FIG. 7, the coordinates of the top-left vertex of the first area 710 are x=0 and y=0, and the width and the height of the first area 710 may be t. The coordinates of the top-left vertex of the second area 720 are x=0 and y=t*a. The width (w) of the second area 720 may bet, and the height (h) may be t*b. The letters a and b are positive numbers less than 1, and may be constants stored in the electronic device 100. Information on the coordinates and size of the second area 720 illustrated in FIG. 7 is an example, and various embodiments implementable by a person skilled in the art are possible. For example, the width (w) of the second area 720 may be smaller than that (e.g., t) of the first area 710.

FIG. 8 illustrates an example of a third area 830 obtained in event data 800 according to various embodiments.

According to an embodiment, the processor 220 may obtain the event data 800 using the DVS 133, while obtaining the image data 500. According to an embodiment, the processor 220 may obtain the third area 830 corresponding to the second area 720 in the event data 800. For example, the image sensor 210 and the DVS 133 are separate sensors, and thus the resolution of the image data 500 and the resolution of the event data 800 may be different from each other. The processor 220 may change the resolution of the second area 720 to obtain the third area 830. As another example, the image sensor 210 and the DVS 133 are separate sensors, and thus the processor 220 may obtain the third area 830 by correcting the time difference and/or the angle-of-view difference between the image data 500 obtained from the image sensor 210 and the event data 800 obtained from the DVS 133. The processor 220 may correct the time difference and/or the angle-of-view difference, based on multi-camera calibration information of each of the image sensor 210 and the DVS 133.

Referring to FIG. 8, a region of interest (ROI)={x, y, w, h} may indicate the position of the second area 720 in the image data 500. For example, x may denote the x coordinate of the top-left vertex of the second area 720, y may denote the y coordinate of the top-left vertex of the second area 720, w may denote the width of the second area 720, and h may denote the height of the second area 720. ROI′={x′, y′, w′, h′} may refer, for example, to the position of the third area 830 in the event data 800. For example, x′ may denote the x coordinate of the top-left vertex of the third area 830, y′ may denote the y coordinate of the top-left vertex of the third area 830, w′ may denote the width of the third area 830, and h′ may denote the height of the third area 830. Referring to FIG. 8, the resolution of the image data 500 may be two times the resolution of the event data 800. For example, the number of horizontal pixels of the image data 500 may be 1600 and the number of vertical pixels may be 900, and the number of horizontal pixels of the event data 800 may be 800 and the number of vertical pixels may be 450. The processor 220 may change the resolution of the second area 720 in a manner of ROI′=ROI*0.5 to obtain the third area 830. Resolution change illustrated in FIG. 8 is an example, and various embodiments are possible. For example, when the resolution difference between the image data 500 and the event data 800 is four times, resolution change may be performed in a manner of ROI′=ROI*0.25.

According to an embodiment, the event data 800 illustrated in FIG. 8 may be understood as the event data 800, shake correction of which has been performed by the processor 220, based on motion data obtained from the motion sensor 230. The processor 220 may obtain the third area 830 in the event data 800, shake correction of which has been performed.

According to an embodiment, the processor 220 may detect a radial movement in the third area 830 of the event data 800. The processor 220 may determine the third area 830 to correspond to the user's eyes, and thus the third area 830 may include information on an event occurring in an area corresponding to the user's eyes. The processor 220 may detect a radial movement (e.g., the radial movement 404 in FIG. 4) generated according to reduction of the user's iris size in the third area 830 of the event data 800.

FIG. 9 illustrates an example of a screen displayed on the display 110 when the surrounding illuminance of the example electronic device 100 is equal to or greater than a designated illuminance according to various embodiments.

According to an embodiment, the processor 220 may measure the illuminance around the electronic device 100 using the illuminance sensor 143. According to an embodiment, the processor 220 may determine, using the illuminance sensor 143, whether the illuminance around the electronic device 100 is less than a designated illuminance, based on receiving of a user input (e.g., the user input in operation 601 of FIG. 6). According to an embodiment, the processor 220 may display a designated screen (e.g., a designated screen described in relation to operation 303 of FIG. 3) on the display 110 based on the illuminance around the electronic device 100 being less than the designated illuminance. In the contents described in relation to FIG. 9, the designated screen may be referred to, for example, as a first screen. According to an embodiment, the processor 220 may determine, using the DVS 133, whether a radial movement is detected, while displaying the first screen on the display 110. That is, when the illuminance around the electronic device 100 is less than the designated illuminance, the processor 220 may perform the operations described with reference to FIG. 3 to FIG. 8.

According to an embodiment, the processor 220 may determine, using the illuminance sensor 143, whether the illuminance around the electronic device 100 is equal to or greater than the designated illuminance. For example, when the illuminance around the electronic device 100 is equal to or greater than the designated illuminance, the user's iris (e.g., the iris 400 in FIG. 4) size may be in a minimally reduced state. In a case in which the user's irises are in a minimally reduced state, even when the quantity of the light emitted from the display 110 increases, it may be difficult for the iris size to be further reduced. Therefore, when the illuminance around the electronic device 100 is equal to or greater than the designated illuminance, the processor 220 may display a screen illustrated in FIG. 9 on the display 110.

Referring to reference numeral 910, the processor 220 may display, on the display 110, a second screen 916 which is distinguished from the first screen and includes an object 914 moving in a designated pattern 912, based on the illuminance around the electronic device 100 being equal to or greater than the designated illuminance. According to an embodiment, the processor 220 may determine whether the user's irises move corresponding to the designated pattern 912, using the DVS 133. For example, while the processor 220 displays the second screen 916 on the display 110, the user may look at the object 914 moving according to the designated pattern 912. While the second screen 916 is displayed on the display 110, the processor 220 may determine whether the user's gaze moves according to the designated pattern 912, using the DVS 133. According to an embodiment, while the second screen 916 is displayed on the display 110, the processor 220 may determine whether the user's irises move corresponding to the designated pattern 912 in the third area 830 of the event data 800.

According to an embodiment, the processor 220 may release a state in which security of the electronic device 100 is configured, based on movement of the user's irises corresponding to the designated pattern 912 and first facial data (e.g., the first facial data 510 in FIG. 5) corresponds to second facial data (e.g., the second facial data 520 in FIG. 5). For example, in a case in which the illuminance around the electronic device 100 is less than a designated illuminance, the processor 220 may determine both whether first facial data corresponds to second facial data and whether a radial movement is detected, and maintain or release security. In a case in which the illuminance around the electronic device 100 is equal to or greater than the designated illuminance, the processor 220 may determine both whether first facial data corresponds to second facial data and whether the user's irises move corresponding to the designated pattern 912, and maintain or release security.

Referring to reference numeral 920, the processor 220 may display, on the display 110, a third screen 922 which is distinguished from the first screen and the second screen 916 and includes a designated object 924, based on the illuminance around the electronic device 100 being equal to or greater than the designated illuminance. User's iris size may be expanded or reduced according to the user's emotion change. Therefore, the processor 220 may display, on the display 110, the third screen 922 including the object 924 (e.g., a scary image) capable of changing the user's emotion. According to an embodiment, the processor 220 may detect a radial movement (e.g., the radial movement 402 or 404 in FIG. 4) using the DVS 133 while displaying the third screen 922 on the display 110. For example, the processor 220 may detect a radial movement in the third area 830 of the event data 800 obtained using the DVS 133.

According to an embodiment, the processor 220 may release a state in which security of the electronic device 100 is configured, based on detection of a radial movement and first facial data corresponding to second facial data. For example, the processor 220 may display different screens (e.g., the first screen or the third screen 922) on the display 110 according to whether the illuminance around the electronic device 100 is less than a designated illuminance or is equal to or greater than the designated illuminance. While the first screen or the third screen 922 is displayed on the display 110, the processor 220 may determine whether first facial data corresponds to second facial data and whether a radial movement is detected, using the DVS 133.

FIG. 10 illustrates an example of an operation of storing the second facial data 520 in the example electronic device 100 according to various embodiments.

According to an embodiment, the processor 220 may detect the first facial data 510 in the image data 500 and compare the detected first facial data with the second facial data 520 stored in the electronic device 100, for example, in operation 309 in FIG. 3 and operation 613 in FIG. 6. The processor 220 may store the second facial data 520 in the electronic device 100 before performing the operations illustrated in FIG. 3 and FIG. 6. For example, the electronic device 100 may include a memory electrically connected to the processor 220, and the processor 220 may obtain an image including the face of a user (e.g., a main user) using the image sensor 210, detect the second facial data 520 in the image, and store the second facial data 520 in the memory.

Referring to FIG. 10, the processor 220 may perform an operation of storing the second facial data 520 in relation to a state in which security of the electronic device 100 is configured. For example, the processor 220 may obtain the second facial data 520 corresponding to the face of a user (e.g., a main user) via a setting application. The user may register, in the electronic device 100, the second facial data 520 corresponding to the face of the user through [Settings]—[Biometric and security 1010]—[Face recognition 1020]. According to an embodiment, the processor 220 may display, on the display 110, a screen through which whether the user wears glasses is selectable. For example, when the user selects that the user does not wear glasses, the processor 220 may display a screen 1032 on the display 110. As another example, when the user selects that the user wears glasses, the processor 220 may display a screen 1034 on the display 110. According to an embodiment, the processor 220 may obtain an image including the user's face using the image sensor 210 while displaying a screen 1040 on the display 110. The processor 220 may detect the second facial data 520 in the image and store the detected second facial data 520 in the memory. For example, the second facial data 520 may indicate data enabling specification of the face of the user (e.g., a main user). The screens 1010, 1020, 1032, 1034, and 1040 illustrated in FIG. 10 are merely examples, and various screens may be used.

An electronic device according to an example embodiment may include a display, an image sensor, a dynamic vision sensor (DVS), and at least one processor electrically connected to the display, the image sensor, and the DVS. The at least one processor may be configured to receive a user input in a state in which security of the electronic device is configured, display a designated screen on the display based on receiving of the user input, obtain image data including a user's face using the image sensor, detect a radial movement in a part of the face using the DVS while obtaining the image data, detect first facial data corresponding to the face in the image data and compare the first facial data with second facial data stored in the electronic device, and release the state in which the security is configured, based on the radial movement being detected and the first facial data corresponding to the second facial data.

In the electronic device according to an example embodiment, the at least one processor may be configured to obtain event data using the DVS while obtaining the image data, obtain a first area corresponding to the face in the image data, obtain a second area corresponding to the user's eye in the first area of the image data, and obtain a third area corresponding to the second area in the event data.

In the electronic device according to an example embodiment, the at least one processor may be configured to detect the first facial data in the first area of the image data, and detect the radial movement in the third area of the event data.

The electronic device according to an example embodiment may further include a motion sensor electrically connected to the at least one processor, and the at least one processor may be configured to obtain motion data corresponding to a movement of the electronic device using the motion sensor while obtaining the event data, perform shake correction of the event data, based on the motion data, and obtain the third area in the (shake-corrected) event data, the shake correction of which has been performed.

In the electronic device according to an example embodiment, the at least one processor may be configured to detect the radial movement generated by reduction of the user's iris size by using the DVS while the designated screen is displayed on the display.

The electronic device according to an example embodiment may further include an illuminance sensor configured to measure an illuminance around the electronic device, and the at least one processor may be configured to, based on receiving of the user input, determine, using the illuminance sensor, whether the illuminance around the electronic device is smaller than (less than) a designated illuminance, based on the illuminance around the electronic device being less than the designated illuminance, display a first screen corresponding to the designated screen on the display, and detect the radial movement using the DVS.

In the electronic device according to an example embodiment, the at least one processor may be configured to, based on the illuminance around the electronic device being equal to or greater than the designated illuminance, display, on the display, a second screen different from the first screen and which includes an object moving in a designated pattern, and determine, using the DVS, whether the user's iris moves corresponding to the designated pattern.

In the electronic device according to an example embodiment, the at least one processor may be configured to maintain the state in which the security is configured, based on the radial movement being not detected or the first facial data not corresponding to the second facial data.

An operation method of an electronic device according to an example embodiment may include receiving a user input in a state in which security of the electronic device is configured, displaying a designated screen on a display included in the electronic device based on receiving of the user input, obtaining image data including a user's face using an image sensor included in the electronic device, detecting a radial movement in a part of the face using a DVS included in the electronic device while obtaining the image data, detecting first facial data corresponding to the face in the image data and comparing the first facial data with second facial data stored in the electronic device, and releasing the state in which the security is configured, based on the radial movement being detected and the first facial data corresponding to the second facial data.

In the operation method of the electronic device according to an example embodiment, the detecting of the radial movement using the DVS may include obtaining event data using the DVS while obtaining the image data, obtaining a first area corresponding to the face in the image data and obtaining a second area corresponding to the user's eye in the first area, and obtaining a third area corresponding to the second area in the event data.

In the operation method of the electronic device according to an example embodiment, the detecting of the radial movement using the DVS may include detecting the radial movement in the third area of the event data, and the detecting of the first facial data and the comparing of the first facial data with the second facial data may include detecting the first facial data in the first area of the image data.

In the operation method of the electronic device according to an example embodiment, the detecting of the radial movement using the DVS may include obtaining motion data corresponding to a movement of the electronic device using a motion sensor included in the electronic device while obtaining the event data, performing shake correction of the event data, based on the motion data, and obtaining the third area in the (shake-corrected) event data, the shake correction of which has been performed.

In the operation method of the electronic device according to an example embodiment, the detecting of the radial movement using the DVS may include detecting the radial movement generated by reduction of the user's iris size using the DVS while the designated screen is displayed on the display.

The operation method of the electronic device according to an example embodiment may include, based on receiving of the user input, determining, using an illuminance sensor included in the electronic device, whether an illuminance around the electronic device is less than a designated illuminance, based on the illuminance around the electronic device being less than the designated illuminance, displaying a first screen corresponding to the designated screen on the display, and detecting the radial movement using the DVS.

The operation method of the electronic device according to an example embodiment may include, based on the illuminance around the electronic device being equal to or greater than the designated illuminance, displaying, on the display, a second screen different from the first screen and which includes an object moving in a designated pattern, and determining, using the DVS, whether the user's iris moves corresponding to the designated pattern.

An electronic device according to an example embodiment may include a display, an image sensor, a DVS, and at least one processor electrically connected to the display, the image sensor, and the DVS. The at least one processor may be configured to receive a user input in a state in which security of the electronic device is configured, display a designated screen on the display based on receiving of the user input, obtain image data including a user's face using the image sensor, obtain event data using the DVS while obtaining the image data, obtain a first area corresponding to the face in the image data, obtain a second area corresponding to the user's eye in the first area of the image data, obtain a third area corresponding to the second area in the event data, detect first facial data corresponding to the face in the first area of the image data and compare the first facial data with second facial data stored in the electronic device, detect a radial movement in the third area of the event data, and release the state in which the security is configured, based on the radial movement being detected and the first facial data corresponding to the second facial data.

The electronic device according to an example embodiment may further include an illuminance sensor configured to measure an illuminance around the electronic device, and the at least one processor may be configured to, based on receiving of the user input, determine, using the illuminance sensor, whether the illuminance around the electronic device is less than a designated illuminance, based on the illuminance around the electronic device being less than the designated illuminance, display a first screen corresponding to the designated screen on the display, and detect the radial movement in the third area of the event data.

In the electronic device according to an example embodiment, the at least one processor may be configured to, based on the illuminance around the electronic device being equal to or greater than the designated illuminance, display, on the display, a second screen different from the first screen and which includes an object moving in a designated pattern, and determine whether the user's iris moves corresponding to the designated pattern in the third area of the event data.

In the electronic device according to an example embodiment, the at least one processor may be configured to release the state in which the security is configured, based on determination of movement of the iris corresponding to the designated pattern in the third area of the event data, and the first facial data corresponding to the second facial data.

In the electronic device according to an example embodiment, the at least one processor may be configured to, based on the illuminance around the electronic device being equal to or greater than the designated illuminance, display, on the display, a third screen that is different from the first screen and which includes a designated object, and detect the radial movement in the third area of the event data.

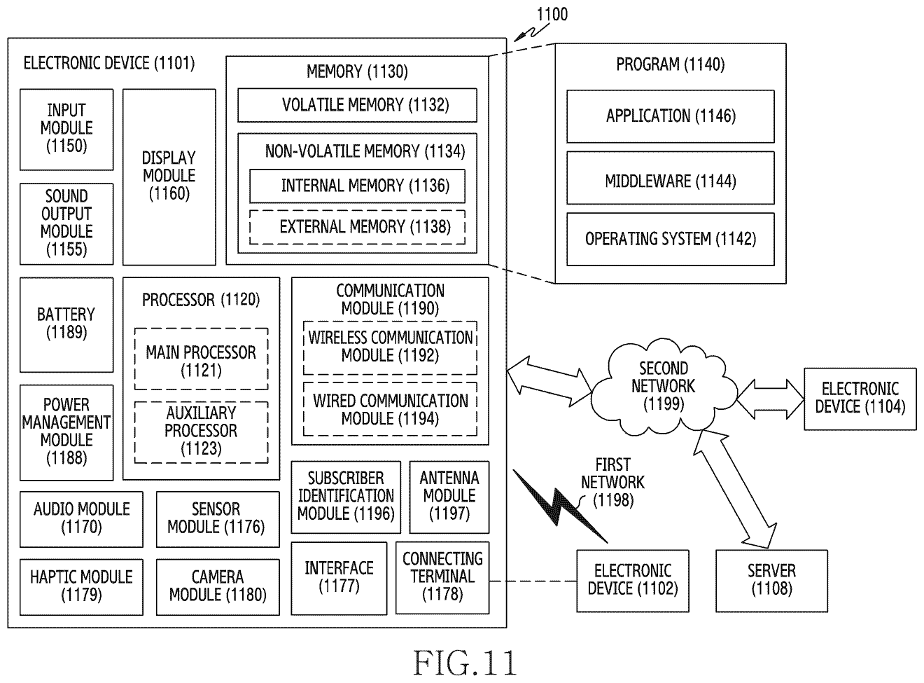

FIG. 11 is a block diagram illustrating an example electronic device 1101 in a network environment 1100 according to various embodiments. Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In various embodiments, at least one of the components (e.g., the connecting terminal 1178) may be omitted from the electronic device 1101, or one or more other components may be added in the electronic device 1101. In various embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of, the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of, the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, a HDMI connector, a USB connector, a SD card connector, or an audio connector (e.g., a headphone connector).

The haptic module 1179 may convert an electrical signal into a mechanical stimulus (e.g., a vibration or a movement) or electrical stimulus which may be recognized by a user via tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™ wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of or including a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In an embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and are intended to include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and do not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Theterm “non-transitory” refers to the storage medium being a tangible device, and does not include a signal (e.g., an electromagnetic wave), but this term does not differentiate between data being semi-permanently stored in the storage medium and data being temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

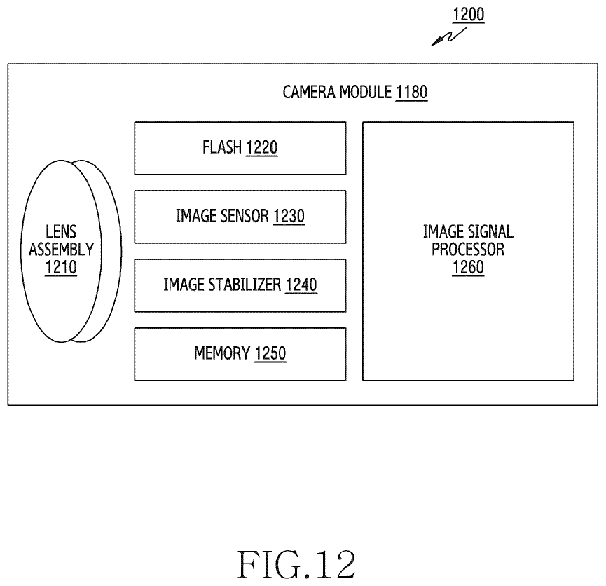

FIG. 12 is a block diagram 1200 illustrating an example camera module 1180 according to various embodiments. Referring to FIG. 12, the camera module 1180 may include a lens assembly 1210, a flash 1220, an image sensor 1230, an image stabilizer 1240, memory 1250 (e.g., buffer memory), or an image signal processor 1260. The lens assembly 1210 may collect light emitted or reflected from an object whose image is to be taken. The lens assembly 1210 may include one or more lenses. According to an embodiment, the camera module 1180 may include a plurality of lens assemblies 1210. In such a case, the camera module 1180 may form, for example, a dual camera, a 360-degree camera, or a spherical camera. Some of the plurality of lens assemblies 1210 may have the same lens attribute (e.g., view angle, focal length, auto-focusing, f number, or optical zoom), or at least one lens assembly may have one or more lens attributes different from those of another lens assembly. The lens assembly 1210 may include, for example, a wide-angle lens or a telephoto lens.

The flash 1220 may emit light that is used to reinforce light reflected from an object. According to an embodiment, the flash 1220 may include one or more light emitting diodes (LEDs) (e.g., a red-green-blue (RGB) LED, a white LED, an infrared (IR) LED, or an ultraviolet (UV) LED) or a xenon lamp. The image sensor 1230 may obtain an image corresponding to an object by converting light emitted or reflected from the object and transmitted via the lens assembly 1210 into an electrical signal. According to an embodiment, the image sensor 1230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 1230 may be implemented using, for example, a charged coupled device (CCD) sensor or a complementary metal oxide semiconductor (CMOS) sensor.

The image stabilizer 1240 may move the image sensor 1230 or at least one lens included in the lens assembly 1210 in a particular direction, or control an operational attribute (e.g., adjust the read-out timing) of the image sensor 1230 in response to the movement of the camera module 1180 or the electronic device 1101 including the camera module 1180. This allows compensating for at least part of a negative effect (e.g., image blurring) by the movement on an image being captured. According to an embodiment, the image stabilizer 1240 may sense such a movement by the camera module 1180 or the electronic device 1101 using a gyro sensor (not shown) or an acceleration sensor (not shown) disposed inside or outside the camera module 1180. According to an embodiment, the image stabilizer 1240 may be implemented, for example, as an optical image stabilizer. The memory 1250 may store, at least temporarily, at least part of an image obtained via the image sensor 1230 for a subsequent image processing task. For example, if image capturing is delayed due to shutter lag or multiple images are quickly captured, a raw image obtained (e.g., a Bayer-patterned image, a high-resolution image) may be stored in the memory 1250, and its corresponding copy image (e.g., a low-resolution image) may be previewed via the display module 1160. Thereafter, if a specified condition is met (e.g., by a user's input or system command), at least part of the raw image stored in the memory 1250 may be obtained and processed, for example, by the image signal processor 1260. According to an embodiment, the memory 1250 may be configured as at least part of the memory 1130 or as a separate memory that is operated independently from the memory 1130.

The image signal processor 1260 may perform one or more image processing with respect to an image obtained via the image sensor 1230 or an image stored in the memory 1250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 1260 may perform control (e.g., exposure time control or read-out timing control) with respect to at least one (e.g., the image sensor 1230) of the components included in the camera module 1180. An image processed by the image signal processor 1260 may be stored back in the memory 1250 for further processing, or may be provided to an external component (e.g., the memory 1130, the display module 1160, the electronic device 1102, the electronic device 1104, or the server 1108) outside the camera module 1180.

According to an embodiment, the image signal processor 1260 may be configured as at least part of the processor 1120, or as a separate processor that is operated independently from the processor 1120. If the image signal processor 1260 is configured as a separate processor from the processor 1120, at least one image processed by the image signal processor 1260 may be displayed, by the processor 1120, via the display module 1160 as it is or after being further processed.

According to an embodiment, the electronic device 1101 may include a plurality of camera modules 1180 having different attributes or functions. In such a case, at least one of the plurality of camera modules 1180 may form, for example, a wide-angle camera and at least another of the plurality of camera modules 1180 may form a telephoto camera. Similarly, at least one of the plurality of camera modules 1180 may form, for example, a front camera and at least another of the plurality of camera modules 1180 may form a rear camera.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
an image sensor;
a dynamic vision sensor (DVS); and
at least one processor electrically connected to the display, the image sensor, and the DVS,
wherein memory storing instructions that, when executed by the at least one processor, cause the electronic device to:
receive a user input in a state in which security of the electronic device is configured;
display a designated screen on the display based on receiving of the user input;
obtain image data including a user's face using the image sensor;
detect a radial movement in a part of the face using the DVS while obtaining the image data;
detect first facial data corresponding to the face in the image data and compare the first facial data with second facial data stored in the electronic device; and
release the state in which the security is configured, based on the radial movement being detected and the first facial data corresponding to the second facial data.

2. The electronic device of claim 1, wherein the instructions, when executed by the at least one processor cause the electronic device to:
obtain event data using the DVS while obtaining the image data;
obtain a first area corresponding to the face in the image data;
obtain a second area corresponding to the user's eye in the first area of the image data; and
obtain a third area, in the event data, corresponding to the second area .

3. The electronic device of claim 2, wherein the instructions, when executed by the at least one processor cause the electronic device to:
detect the first facial data in the first area of the image data; and
detect the radial movement in the third area.

4. The electronic device of claim 3, further comprising a motion sensor electrically connected to the at least one processor,
wherein the instructions, when executed by the at least one processor cause the electronic device to:
obtain motion data corresponding to a movement of the electronic device using the motion sensor while obtaining the event data;
perform shake correction of the event data, based on the motion data; and
obtain the third area in the shake-corrected event data.

5. The electronic device of claim 1, wherein the instructions, when executed by the at least one processor cause the electronic device to detect the radial movement generated by reduction of the user's iris size using the DVS while the designated screen is displayed on the display.

6. The electronic device of claim 1, further comprising an illuminance sensor configured to measure an illuminance around the electronic device,
wherein the instructions, when executed by the at least one processor cause the electronic device to:
based on receiving of the user input, determine, using the illuminance sensor, whether the illuminance around the electronic device is less than a designated illuminance;
based on the illuminance around the electronic device being less than the designated illuminance, display a first screen corresponding to the designated screen on the display; and
detect the radial movement using the DVS.

7. The electronic device of claim 6, wherein the instructions, when executed by the at least one processor cause the electronic device to:
based on the illuminance around the electronic device being equal to or greater than the designated illuminance, display, on the display, a second screen different from the first screen and which includes an object moving in a designated pattern; and
determine, using the DVS, whether movement of the user's iris corresponds to the designated pattern.

8. The electronic device of claim 1, wherein the instructions, when executed by the at least one processor cause the electronic device to maintain the state in which the security is configured, based on the radial movement not being detected or the first facial data not corresponding to the second facial data.

9. An operation method of an electronic device, the operation method comprising:
receiving a user input in a state in which security of the electronic device is configured;
displaying a designated screen on a display included in the electronic device based on receiving of the user input;
obtaining image data including a user's face using an image sensor included in the electronic device;
detecting a radial movement in a part of the face using a DVS included in the electronic device while obtaining the image data;
detecting first facial data corresponding to the face in the image data and comparing the first facial data with second facial data stored in the electronic device; and
releasing the state in which the security is configured, based on the radial movement being detected and the first facial data corresponding to the second facial data.

10. The operation method of claim 9, wherein the detecting of the radial movement using the DVS comprises:
obtaining event data using the DVS while obtaining the image data;
obtaining a first area corresponding to the face in the image data and obtaining a second area corresponding to the user's eye in the first area; and
obtaining a third area, in the event data, corresponding to the second area.

11. The operation method of claim 10, wherein the detecting of the radial movement using the DVS comprises detecting the radial movement in the third area, and
the detecting of the first facial data and the comparing of the first facial data with the second facial data comprise detecting the first facial data in the first area of the image data.

12. The operation method of claim 11, wherein the detecting of the radial movement using the DVS comprises:
obtaining motion data corresponding to a movement of the electronic device using a motion sensor included in the electronic device while obtaining the event data;
performing shake correction of the event data, based on the motion data; and
obtaining the third area in the shake-corrected event data.

13. The operation method of claim 9, wherein the detecting of the radial movement using the DVS comprises detecting the radial movement generated by reduction of the user's iris size using the DVS while the designated screen is displayed on the display.

14. The operation method of claim 9, further comprising:
based on receiving of the user input, determining, using an illuminance sensor included in the electronic device, whether an illuminance around the electronic device is less than a designated illuminance;
based on the illuminance around the electronic device being less than the designated illuminance, displaying a first screen corresponding to the designated screen on the display; and
detecting the radial movement using the DVS.

15. The operation method of claim 14, further comprising:
based on the illuminance around the electronic device being equal to or greater than the designated illuminance, displaying, on the display, a second screen different from the first screen and which includes an object moving in a designated pattern; and
determining, using the DVS, whether movement of the user's iris corresponds to the designated pattern.
